(19) United States
(12) Patent Application Publication
(10) Pub. No.: US 2007/0226803 A1
(43) Pub. Date: Sep. 27, 2007

(54) System and method for detecting internet worm traffics through classification of traffic characteristics by types

(76) Inventors: Woonyon Kim, Daejeon (KR); Dongsoo Kim, Daejeon (KR); Daesik Choi, Daejeon (KR); Eungki Park, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/453,448

(22) Filed: Jun. 15, 2006

(30) Foreign Application Priority Data
Mar. 22, 2006 (KR) 2006-26267

(51) Int. Cl. G06F 12/14; H04L 9/32; G06F 11/00; G06F 11/30; G06F 12/16; G06F 15/18; G08B 23/00

(52) U.S. Cl. 726/24; 713/188

(57) ABSTRACT

A system and method for detecting Internet worm traffics through classification of traffic characteristics by types is disclosed. The system and method defines Internet worm as a characteristic profile classified into diverse traffic characteristics, detects Internet worm traffics by comparing the similarity of a collected traffic with that of a defined traffic, classifies the type of the Internet worm, and performs severity judgment and alarming. The detection efficiency of most worms, which cannot be detected based on the existing rule, can be increased. Also, the risk grade of the corresponding worm traffic can be quantitatively provided by judging the severity according to the similarity scores and the predefined severity grade. Accordingly, the survival of the entire communication network can be heightened through the countermeasure and the forecast/alarm in steps, and mass information can be effectively seized.

### BACKGROUND OF THE INVENTION

1. Field of the Invention

The present invention relates to the Internet worm detection, and more particularly to a system and method for detecting Internet worm traffics through classification of traffic characteristics by types, performing type classification, judging the severity, and giving an alarm, which can properly cope with even diverse variants by applying a detection method through the result of analysis of worm, getting out of the existing method that detects worm traffics through the cause of the worm.

2. Background of the Related Art

With the rapid growth of Internet, it provides diverse advantages, but includes many problems. The biggest problem among the problems is related to the security. At present, many systems on Internet are becoming the subject of attack, and such attacks include hacker's direct intrusions and automatized intrusions that inflict an injury on a system such as Internet worms.

The Internet worm is a program that copies and transmits itself to other computers connected on a network. A model for detecting intrusion behavior is classified into a misuse intrusion detection model and an abnormal intrusion detection model.

The misuse intrusion is a model which detects the intrusion based on a pattern and which is used by an intrusion detection system (IDS) or worm * virus vaccines. This misuse intrusion detection model has the drawback in that it detects the intrusion based on the pattern, and thus it cannot detect a new intrusion or Internet worm until analysis of an occurred accident is completed and the pattern is updated.

The abnormal intrusion detection model creates a model for a normal behavior pattern using proper algorithm, and automatically detects a behavior that deviates from the model. This model has an advantage that it can detect an unknown attack or an attack of a new or modified worm, but has a disadvantage that it may misdetect a normal behavior pattern, which is a new unlearned pattern that is not an attack behavior, as an attack. This abnormal behavior detection model is briefly divided into a predicted model and an explanatory model. The predicted model discriminates whether a data set presented through learning is normal or abnormal after a normal data set for learning is provided. Techniques that affect the predicted model may be ADAM, PHAD, NIDES, artificial intelligence, information theoretic measures, network activity models, and others. Unlike the predicted model, the explanatory model detects an abnormal behavior pattern without any prior information on learning data, and is theoretically based on statistical access, clustering, outlier detection, state machine, and others.

The existing method for detecting Internet worm and modified Internet worm detects intrusions by an already known rule and pattern, suing the misuse intrusion detection model. This method has the drawback in that it can detect a new worm or a modified worm only after samples of the corresponding worm are collected and analyzed, and then established as a detectable pattern. Since this misuse intrusion detection model uses a known pattern, it is simple and has a high accuracy, but it cannot detect a new worm or a modified worm. Accordingly, a method that can detect a new or modified Internet worm without any fixed pattern is required.

On the other hand, since the abnormal intrusion detection model does not use any specific pattern such as a traffic statistical characteristic of a network, it can partly achieve a non-pattern detection of Internet worm, and cope with new worm * virus or intrusion. However, this model is yet in its early research stages, and research for an abnormal detection of network traffic or the like is still in progress.

Accordingly, an early alarming and countermeasure against Internet worm after the detection of worm * virus or intrusion plays a very important role as preventive measures for the survival of the entire network. ISC (Internet Storm Center) support team monitors data flowing into databases using automatized analysis tools and visualization tools, and retrieves activities corresponding to attacks through all the areas. The ISC support team notifies Internet community of symptoms found by the team through the main website of ISC, or directly notifies ISPs, news groups, or public information sharing forums of the symptoms through email and notice. However, these forecasts * alarms refer to a forecasting * alarming method for merely reporting the state of damages rather than an automatized method, and refers to a system for generating an alarm and countermeasure after the deliver of an attack, which requires improvements.

### SUMMARY OF THE INVENTION

Accordingly, the present invention is directed to a system and method for detecting Internet worm traffics through classification of traffic characteristics by types, which substantially obviates one or more problems due to limitations and disadvantages of the related art.

It is an object of the present invention to provide a system and method for detecting Internet worm traffics through classification of traffic characteristics by types, which defines Internet worm as a characteristic profile classified into diverse traffic characteristics, detects Internet worm traffics by comparing the similarity of a collected traffic with that of a defined traffic, classifies the type of the Internet worm, and performs severity judgment and alarming.

It is another object of the present invention to provide a system and method for detecting Internet worm traffics through traffic characteristic classification by types, which detects a new worm or a modified worm without any fixed pattern, provides a countermeasure according to the characteristic of the worm and the degree of severity, and gives an alarm accordingly. For this, the system and method according to the present invention performs a grouping of diverse Internet worms, prepares a worm traffic characteristic profile that defines specified vectors through diverse statistical methods, information theoretic measures, and others, and generates characteristic vectors for the traffic collected for a predetermined period. The system and method compares the similarities of characteristic vectors of the collected traffics with those of a predefined group, and decides the traffic type having the highest similarity. The system and method also judges the severity according to the severity scores in a predefined range from “normal” to “severe”, according to the similarity scores of the decided traffic type, provides a countermeasure according to the severity grade of the decided traffic type, and gives an alarm accordingly.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

In order to achieve the above objects, there is provided a system for detecting Internet worm traffics through classification of traffic characteristics by types, that performs an Internet worm traffic type classification, a severity judgment, and an alarming, according to the present invention, which includes a traffic collection and integration unit for collecting, analyzing, and storing network traffics for a predetermined time; a traffic characteristic vector generation unit for generating traffic characteristic vectors using characteristic filters from the traffics collected for the predetermined time; a similarity analysis unit for generating similarity scores between the generated traffic characteristic vectors and respective types in a predefined worm traffic characteristic profile; a traffic type decision unit for deciding the traffic types using the similarity scores generated for the type in the predefined worm traffic characteristic profile; a severity judgment unit for judging a severity grade by comparing the similarity scores of the decided traffic type with a predefined severity judgment score range; and a countermeasuring and alarming unit for performing a countermeasure and an alarming according to the result of judgment.

In another aspect of the present invention, there is provided a method for detecting Internet worm traffics through classification of traffic characteristics by types, that performs an Internet worm traffic type classification, a severity judgment, and an alarming, which comprises the steps of constituting a worm traffic characteristic profile in which traffic characteristic vectors by groups are defined by grouping in advance Internet worms; generating characteristic vectors for traffics collected for a predetermined time, performing a similarity comparison of the generated characteristic vectors with traffic characteristic vectors predefined by groups, and deciding a worm traffic type having the highest similarity scores; judging a severity grade by comparing similarity scores of the decided traffic type with reference scores by severity judgment grades predefined from “normal” to “severe”; providing a countermeasure on the severity grade of the decided traffic type, and judging whether a user alarm exists; and if the user alarm is required as a result of judging whether the user alarm exists, performing a countermeasure by predefined traffic types and risk grades, and giving an alarm to a manager through an alarm means.

The method for detecting Internet worm traffics through classification of traffic characteristics by types according to the present invention includes the step of initially adjusting a predefined worm traffic characteristic profile by adjusting characteristic vectors by types of the worm traffic characteristic profiles to match an installation time.

The step of initially adjusting the worm traffic characteristic profile includes the steps of collecting packets, and generating traffic basic information by analyzing a header of the collected packet; storing the generated traffic basic information in a traffic basic information database; generating traffic characteristic values by types using the collected traffic basic information, and storing the generated traffic characteristic values in a characteristic value database; judging whether a period for generating the worm traffic characteristic profile is completed, and if the period for generating the worm traffic characteristic profile is completed as a result of judgment,. generating a characteristic value profile for a normal-time traffic of an installation means, using the characteristic value database; and constituting the worm traffic characteristic profile by adjusting the stored traffic characteristic values by types by using the characteristic value of the normal-time traffic of the installation means.

According to the system and method for detecting the Internet worm traffics through classification of the traffic characteristics by types, the worm traffics are grouped by traffic characteristics, and the type of the corresponding traffic is defined through the comparison of the similarity of the generated traffic characteristic with the similarity of the grouped traffic characteristic. A proper countermeasure and manager alarming according to the similarity is performed by quantitatively expressing the similarity. Accordingly, a newly appearing or modified worm traffic, which cannot be detected based on the existing rule, can be detected. The corresponding worm can be seized and countermeasured by judging the type of the detected worm traffic as the traffic characteristic, and the risk grade of the corresponding worm traffic can be quantitatively provided by judging the severity according to the similarity scores and the predefined severity grade. The manager is notified of the severity through an SMS message, an email, and a screen popup. Accordingly, the survival of the entire communication network can be heightened through the countermeasure and the forecast/alarm in steps, and mass information can be effectively seized.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating the entire construction of a system for detecting Internet worm traffics through classification of traffic characteristics by types according to an embodiment of the present invention;

FIG. 2 is a flowchart illustrating a process of initially adjusting a characteristic profile of a predefined Internet worm traffics to match a means or position in which the system is installed according to an embodiment of the present invention; and

FIG. 3 is a flowchart illustrating the operation of a system for detecting Internet worm traffics through classification of traffic characteristics by types according to an embodiment of the present invention.

### DETAILED DESCRIPTION OF THE PREFERRED EMBODIMENT

A system and method for detecting Internet worm traffics through classification of traffic characteristics by types according to the preferred embodiment of the present invention will now be explained in detail with reference to the accompanying drawings.

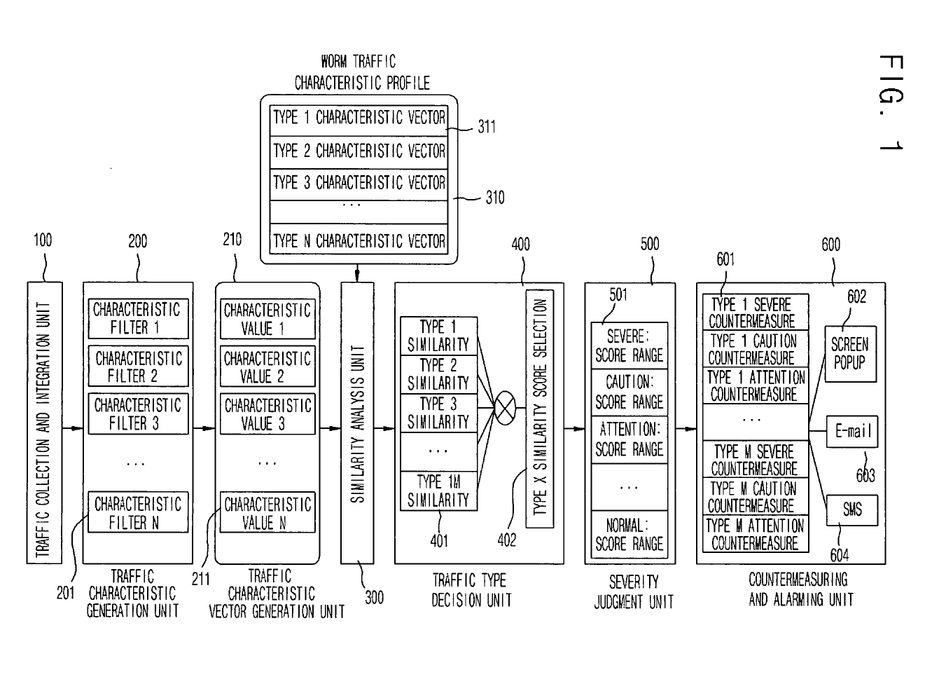

FIG. 1 is a view illustrating the entire construction of a system for detecting Internet worm traffics through classification of traffic characteristics by types, performing type classification, judging the severity, and giving an alarm according to an embodiment of the present invention.

The system for detecting Internet worm traffics through classification of traffic characteristics by types, performing type classification, judging the severity, and giving an alarm, as illustrated in FIG. 1, may be connected using a switch mirroring or tap equipment at a point, to which the Internet of a means is connected, or may be located at a specified host for a host-based detection.

The system for detecting Internet worm traffics through classification of traffic characteristics by types, performing type classification, judging the severity, and giving an alarm, includes a traffic collection and integration unit 100, a traffic characteristic vector generation unit 200, a similarity analysis unit 300, a traffic type decision unit 400, a severity judgment unit 500, a countermeasuring and alarming unit 600.

The traffic collection and integration unit 100 collects diverse basic information of network traffics such as a source IP, a destination IP, a source port, a destination port, a packet length, a protocol, flag information, and others, and stores the basic information in a database, so that the traffic characteristic vector generation unit 200 uses them for an analysis purpose.

The traffic characteristic vector generation unit 200 generates characteristic values 211 by applying diverse characteristic filters 201, using the traffic basic information collected by the traffic collection and integration unit 100 for a predetermined period, and generates traffic characteristic vectors 210 including the generated characteristic values. The characteristic filters 201 may be added or deleted if needed, and the traffic characteristic vectors 210 are changed accordingly.

The traffic characteristic vector generation unit 200 can apply characteristic filters capable of extracting characteristic values of complicated levels such as entropy of the information engineering theory, packet-length distribution statistics, and others, in addition to simple statistical values such as the number of source address IP packets, the number of destination address IP packets, the number of source port packets, the number of destination port packets, and others. The entropy can be constituted based on the basic characteristics such as entropy of a source address IP, entropy of a destination address, entropy of a source port, entropy of a destination port, source IP address—destination IP address entropy, entropy of a packet length, entropy by protocols, entropy for complicated combination of the basic characteristics, and others. The characteristic filters may be added or deleted according to an application environment or the change of technologies, and thus may be provided to be well adapted for the environment and the change of technologies.

The similarity analysis unit 300 generates similarity values between the generated traffic characteristic vectors 210 and characteristic vectors 311 by worm types, which are predefined in a worm traffic characteristic profile 310, by applying diverse similarity analysis techniques. Diverse methods such as a cosine similarity analysis method, a Jaccard similarity analysis method, and a similarity distance analysis method, can be used as the similarity analysis method. Through the similarity analysis unit 300, a similarity value is generated for each predefined worm type.

The traffic type decision unit 400 selects scores 402 of a worm traffic type that is most similar to the traffic characteristic vector 210 among scores of similarity 401 obtained by predefined worm types.

The severity judgment unit 500 judges the severity of the similarity scores of the traffic type currently selected by comparing the similarity scores 402 between the traffic characteristic vector 210 and the selected worm traffic type with the range of the similarity scores defined in the predefined severity types 501.

The countermeasuring and alarming unit 600 performs a countermeasure according to the predefined countermeasures by types 601 corresponding to the judged severity of the selected worm traffic type according to the worm traffic type selected by the traffic type decision unit 400 and the severity judged by the severity judgment unit 500, and performs alarming through a screen popup 602, an email 603, and an SMS message 604.

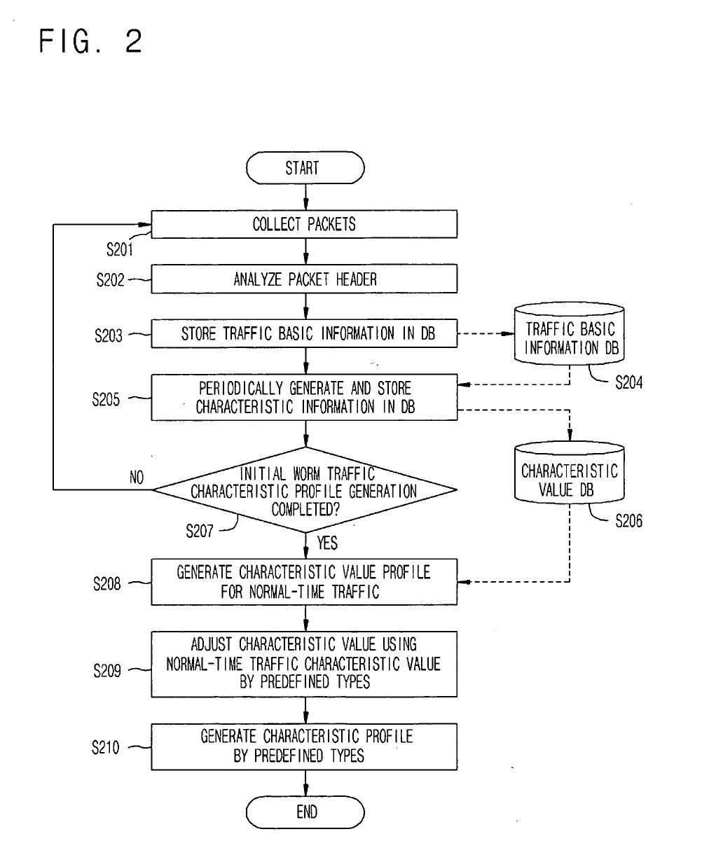

FIG. 2 is a flowchart illustrating a process of initially adjusting a characteristic profile of a predefined Internet worm traffic that is performed by a system for detecting Internet worm traffics through classification of traffic characteristics by types, performing type classification, judging the severity, and giving an alarm, in order to match a means or position in which the system is installed according to an embodiment of the present invention.

The process of initially adjusting the characteristic profile of the predefined Internet worm traffics to match the means or position in which the system is installed is performed as follows. A packet is collected (S201), and the header of the collected packet is analyzed (S202) to generate traffic basic information. The generated traffic basic information is stored (S203) in a basic information database (S204), and a characteristic value is generated using the traffic basic information collected for a corresponding period to store (S205) the generated characteristic value in a characteristic value database (S206). This process is repeated for an initial worm traffic characteristic profile generation period (S207), and the characteristic values are generated and stored in the database.

If the generation of the initial worm traffic characteristic profile is completed (“Yes” in step S207), the characteristic profile for the normal-time traffic of the installation means is generated (S208) using the characteristic database (S206), and the characteristic value is adjusted (S209) using the normal-time traffic characteristic value for each predefined traffic type. The adjustment of the characteristic value is applied to all predefined worm traffic types, and thus the characteristic values constitute a worm traffic characteristic profile (S210). If the generation of the initial worm traffic characteristic profile is not completed (“No” in step S207), the packet collection step returns, and the process is repeated until the generation of the worm traffic characteristic profile is completed.

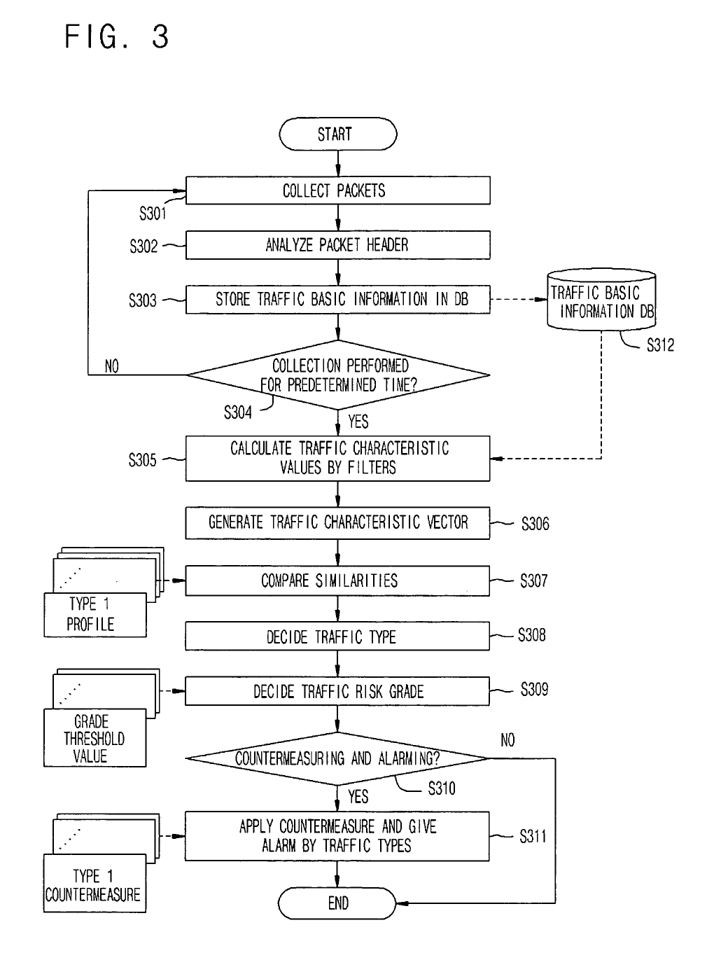

FIG. 3 is a flowchart illustrating the operation of a system for detecting Internet worm traffics through classification of traffic characteristics by types according to an embodiment of the present invention.

In order to perform an Internet worm traffic detection, type classification, severity judgment, and alarming using the initially adjusted worm traffic characteristic profile, the traffic collection and integration unit 100 collects a packet (S301), generates traffic basic information by analyzing the header of the packet (S302), and stores the traffic basic information in a database (S303). This process is repeatedly performed for a predetermined time for performing the analysis (S304). If the collection for the predetermined time is completed, the traffic characteristic vector is generated (S306) by calculating the traffic characteristic value using the traffic basic information stored in the traffic basic information database (S312).

Then, the similarity value is generated by comparing the similarities (S307) through the performing of the similarity analysis between the generated traffic characteristic vector and the type of the predefined worm traffic characteristic profile (S313), the most similar worm traffic type is decided using the generated similarity value (S308), and the traffic risk grade is decided (S309) through the comparison of the decided type with the predefined standard for each traffic severity judgment grade (S314).

It is judged whether the user alarm is necessary by applying the countermeasure for the corresponding traffic to the decided risk grade, and if so (e.g., “Yes”), the corresponding process is performed, while otherwise (e.g., “No”), the corresponding traffic is considered as a normal traffic. That is, if it is judged that the countermeasuring and alarming is necessary (e.g., “Yes”), the countermeasure for each predefined worm traffic type and risk grade is performed, and a corresponding alarm is given to a manager through an alarming means such as a screen popup, email, and SMS message (S311). Otherwise (e.g., “No”), the corresponding traffic is considered as a normal traffic, and the work is terminated.

As described above, according to the present invention, a newly generated or modified worm can be detected by using the characteristic vector obtained by extracting the traffic characteristic for the detection of the Internet worm, and the characteristic that the corresponding worm has can be seized by deciding the traffic type through the similarity analysis. Also, the grade of risk can be measured by judging the severity through the similarity scores of the characteristic vectors, and the spread of the corresponding threat can be met in steps by providing in steps the countermeasure according to the grouped worm traffic characteristics.

As described above, according to the system and method for detecting the Internet worm traffics through classification of the traffic characteristics by types, performing type classification, judging the severity, and giving an alarm according to the present invention, the worm traffics are grouped by traffic characteristics, and the traffic characteristic vectors indicating the traffic characteristics for each group are defined. Also, the type of the corresponding traffic is defined through the comparison of the similarities of the traffic characteristic vectors, and a proper countermeasure and manager alarming according to the similarity is performed by quantitatively expressing the similarity. Accordingly, a newly appearing or modified worm traffic, which cannot be detected based on the existing rule, can be detected. In addition, the influence to be exerted by the corresponding worm can be seized and countermeasured by judging the type of the detected worm traffic as the traffic characteristic, and the risk grade of the corresponding worm traffic can be quantitatively provided by judging the severity according to the similarity scores and the predefined severity grade. Accordingly, the survival of the entire communication network can be heightened through the countermeasure and the forecast/alarm in steps, and mass information can be effectively seized.

While the system and method for detecting Internet worm traffics through classification of traffic characteristics by types according to the present invention has been described and illustrated herein with reference to the preferred embodiment thereof, it will be understood by those skilled in the art that various changes and modifications may be made to the invention without departing from the spirit and scope of the invention, which is defined in the appended claims.

What is claimed is:

1. A system for detecting Internet worm traffics through classification of traffic characteristics by types, the system comprising:
a traffic collection and integration unit for collecting, analyzing, and storing network traffics for a predetermined time;
a traffic characteristic vector generation unit for generating traffic characteristic vectors using characteristic filters from the traffics collected for the predetermined time;
a similarity analysis unit for generating similarity scores between the generated traffic characteristic vectors and respective types in a predefined worm traffic characteristic profile;
a traffic type decision unit for deciding the traffic types using the similarity scores generated for the type in the predefined worm traffic characteristic profile;
a severity judgment unit for judging a severity grade by comparing the similarity scores of the decided traffic type with a predefined severity judgment score range; and
a countermeasuring and alarming unit for performing a countermeasure and an alarming according to the result of judgment.

2. The system as claimed in claim 1, wherein the traffic collection and integration unit collects diverse basic information of the network traffics such as a source EP, a destination IP, a source port, a destination port, a packet length, a protocol, and flag information, and stores the basic information in a database, so that the traffic characteristic vector generation unit uses them for an analysis purpose.

3. The system as claimed in claim 1, wherein the traffic characteristic vector generation unit applies characteristic filters that can be added or deleted, and generates simple statistical values that include a source IP address, a destination IP address, a source port number, a destination port number, a packet length, a protocol, a packet flag, and a source IP address—destination IP address and entropies for the simple statistical items, as the characteristic values, using the traffic information collected for the predetermined time.

4. The system as claimed in claim 1, wherein the similarity analysis unit calculates the similarity by diverse similarity analysis methods including such as a cosine similarity analysis method and a Jaccard similarity analysis method,

5. The system as claimed in claim 1, wherein the countermeasuring and alarming unit performs a countermeasure corresponding to the similarity grade decided by the similarity judgment unit by types of worm traffics decided by the traffic type decision unit, and gives an alarm to a manager through a screen popup, an email, and an SMS message.

6. A method for detecting Internet worm traffics through classification of traffic characteristics by types, performing type classification, performing severity judgment, and giving an alarm, the method comprising the steps of:
constituting a worm traffic characteristic profile in which traffic characteristic vectors by groups are defined by grouping in advance Internet worms;
generating characteristic vectors for traffics collected for a predetermined time, performing a similarity comparison of the generated characteristic vectors with traffic characteristic vectors predefined by groups, and deciding a worm traffic type having the highest similarity scores;
judging a severity grade by comparing similarity scores of the decided traffic type with reference scores by severity judgment grades predefined from “normal” to “severe”;
providing a countermeasure on the severity grade of the decided traffic type, and judging whether a user alarm exists; and
if the user alarm is required as a result of judging whether the user alarm exists, performing a countermeasure by predefined traffic types and risk grades, and giving an alarm to a manager through an alarm means.

7. The method as claimed in claim 6, wherein if the user alarm is required as a result of judgment of whether the user information exists, the traffic is considered as a normal traffic.

8. The method as claimed in claim 6, further comprising the step of initially adjusting a predefined worm traffic characteristic profile by adjusting characteristic vectors by types of the predefined worm traffic characteristic profile to match an installation time.

9. The method as claimed in claim 8, wherein the step of initially adjusting the worm traffic characteristic profile comprises the steps of:
collecting packets, and generating traffic basic information by analyzing a header of the collected packet;
storing the generated traffic basic information in a traffic basic information database;
generating traffic characteristic values by types using the collected traffic basic information, and storing the generated traffic characteristic values in a characteristic value database;
judging whether a period for generating the worm traffic characteristic profile is completed, and if the period for generating the worm traffic characteristic profile is completed as a result of judgment, generating a characteristic value profile for a normal-time traffic of an installation means, using the characteristic value database; and
constituting the worm traffic characteristic profile by adjusting the stored traffic characteristic values by types by using the characteristic value of the normal-time traffic of the installation means.

10. The method as claimed in claim 9, wherein if the period for generating the worm traffic characteristic profile is not completed as a result of judgment, returning to the packet collection step, and repeatedly performing the process until the generation of the worm traffic characteristic profile is completed.

11. The method as claimed in claim 9, wherein the normal-time characteristic indicates the traffic characteristic as a result of operating the traffic characteristics of an installation means.
